(19) United States
(12) Patent Application Publication
(10) Pub. No.: US 2026/0115986 A1
(43) Pub. Date: Apr. 30, 2026

(54) HIGH-FIDELITY PRESSURE CONTROL OF INJECTION MANUFACTURING PROCESSES USING PRIMARY AND AUXILARY PRESSURE SENSORS

(71) Applicant: The Procter & Gamble Company, Cincinnati, OH (US)

(72) Inventors: Gene Michael ALTONEN, West Chester, OH (US); Richard Matthew GIACHETTO, Loveland, OH (US); Chad Michael MORRIS, Liberty Township, OH (US)

(21) Appl. No.: 19/420,990

(22) Filed: Dec. 16, 2025

Related U.S. Application Data
(63) Continuation of application No. PCT/US2024/033946, filed on Jun. 14, 2024.
(60) Provisional application No. 63/521,500, filed on Jun. 16, 2023.

(51) Int. Cl. B29C 45/77

(52) U.S. Cl. CPC B29C 45/77; B29C 2945/76006; B29C 2945/7621; B29C 2945/76214; B29C 2945/76498; B29C 2945/76665; B29C 2945/76859

(57) ABSTRACT

A system for achieving high-definition pressure control of manufacturing operations utilizes data from one or more primary sensors, each of which is associated with a relatively high degree of accuracy based on the primary sensor's proximity to material involved in the manufacturing operation, as well as data from one or more secondary sensors, each of which is located more remote from the material involved in the manufacturing operation than the primary sensors. Data from the one or more primary sensors is evaluated to detect errors or trends indicative of primary sensor failure. Suspect or compromised primary sensor data is then disregarded or filtered, using data from the secondary sensors, historical data, or some combination thereof.

### FIELD OF THE DISCLOSURE

This disclosure relates generally to pressure control of manufacturing processes and, more particularly, to increasing the fidelity of pressure control by adjustment of manufacturing parameters based on (i) real-time, near-real time, historical, and/or offset pressure data provided by one or more primary sensors susceptible to reliability challenges such as electromagnetic interference, extreme temperatures, and/or abrasive media involved in the manufacturing operation, (ii) data indicative of pressure provided by one or more auxiliary sensors which are more remote from, or otherwise resistant to, such reliability challenges, and (iii) selective consideration of such real-time and offset pressure data from either the one or more primary sensors or the one or more auxiliary sensors, or some combination of them, to minimize effects of outlier readings or erroneous data.

### BACKGROUND

A variety of manufacturing processes utilize pressure control to manage the introduction of one or more media to a cavity or region of a manufacturing system. For instance, injection molding systems typically employ hydraulic pressure sensors during the packing or holding phases of a conventional injection molding process or during a constant pressure-controlled process. The hydraulic pressure sensors measuring the hydraulic pressure exerted on the back of an injection piston, or load cells measuring the amount of force exerted on a load cell on the back of a screw, either of which are disposed well upstream of a gate at an inlet of one or more mold cavities. Such hydraulic pressure sensors or load cells serve as a proxy for pressure of molten polymeric material in the mold cavity, but are widely used and reasonably reliable. Because hydraulic pressure sensors or load cells (referred to generally herein as “machine sensors”) are isolated from the molten polymeric material entering the mold cavity, they can provide a control signal that is of high quality with respect to stability and consistency. Machine sensors are also generally not exposed to extremely high temperatures, abrasive materials (such as glass microbeads or fibrous resins increasingly prevalent in media used in injection molding, extrusion, and other manufacturing operations), and because they are situated in relatively low “traffic areas” of injection molding systems, are less susceptible to electromagnetic interference (EMI) than melt pressure transducers (MPT) sensors mounted downstream of a screw tip, or proxy sensors, such as ultrasonic sensors or strain gauge sensors, mounted to generate and transmit data indicative of pressure downstream of a screw tip. However, such machine sensors, while more remote from challenges to sensor reliability encountered downstream of a screw tip, are inherently susceptible to error because of their lack of proximity to the molten polymer.

A potential error source for machine sensors is if an operator were to adjust the cushion in front of a shot of molten polymeric material, as this can affect the offset used in calibrating a controller to data received from the machine sensors to produce pressure values expected from a MPT sensor. Additionally, changes in back pressure during the recovery phase of a screw in a barrel of the injection molding system can have unexpected impacts on offset. Other sources of error for machine sensors include friction, compliance of mechanical components, and fluid compression in the media used in the manufacturing operation. Errors from machine sensors are dynamic in the course of a shot of an injection molding system.

As an alternative to machine sensors, MPT sensors may be used as sensors in intimate contact with molten polymeric material downstream of a screw, such as in, or immediately upstream of, a gate or nozzle as the molten polymeric material enters a mold cavity or feed system to a plurality of mold cavities. Alternatives to MPT sensors, such as ultrasonic sensors or strain gauge sensors, may be used to generate and transmit data indicative of pressure at a location downstream of the screw. With MPTs mounted downstream of the screw, due to their immediate proximity to molten polymeric material essentially within the mold cavity, and proxy sensors, such as ultrasonic or strain gauge sensors targeting regions downstream of the screw, some of the potential error sources associated with machine sensors are avoided.

However, MPT sensors and proxy sensors tend to drift out of calibration. They are mounted in or near what might be characterized as a relatively high traffic area of the press or injection molding system. Because they are in fluid communication with molten polymeric material, MPT sensors are inclined to leak and/or delaminate, particularly when exposed to abrasive media, such as polymer having glass beads or fibrous material. Decisions as to what MPT sensors to employ also suffer from competing considerations, such as minimizing size while providing sensors that are sufficiently mechanically robust to withstand the harsh environment to which MPT sensors are exposed, such as temperatures at or above 700° F.

MPT sensors are also delicate sensors, that may need to be used in concert with amplifiers and sensitive electronics that are susceptible to interference and signal distortion. Nonetheless, because hydraulic pressures detected by hydraulic sensors are only exposed to about 10% of the pressures to which actual MPT sensors are exposed, hydraulic pressures often need significant amplification to arrive at what might be considered a proxy for true plastic pressure. MPT sensor and proxy sensors, when functioning properly, can provide high quality representations of true plastic pressure at any given instant, and therefore provide a desirable data source to control and injection molding process.

It would be desirable to provide a manufacturing process that could benefit from the accuracy of pressure sensor data from sensors in immediate proximity to molten polymeric material at the entrance of a mold cavity or feed system to multiple mold cavities, or otherwise downstream of a screw, while also having the reliability of auxiliary sensors, such as machine sensors, positioned more remote from the mold cavity, and that have high quality with respect to stability and consistency.

### SUMMARY OF THE DISCLOSURE

Various manufacturing systems can be controlled with improved precision and efficiency by controlling manufacturing operations in real-time or near-real time with reliable, high precision sensors, referred to herein as primary sensors, in combination with generally reliable secondary sensors that are positioned and selected to be resilient and less susceptible to error. Near-real time applies to calculations or control based on a time difference of up to 1000 milliseconds.

In an injection molding system, for instance, primary sensors, including melt pressure transducer (MPT) sensors, may be mounted in a nozzle adapter or otherwise in front of (i.e., downstream of) a screw tip. Proxy sensors, such as ultrasonic sensors or strain sensors, may be used in lieu of MPT sensors. Secondary sensors may include hydraulic sensors or load cells, generally referred to herein as machine sensors, disposed upstream of the screw, remote from high temperatures and otherwise generally isolated from conditions that contribute to a relatively harsh environment for primary sensors. It should be appreciated that, in some embodiments, the machine sensors may be the primary sensors and the MPT or proxy sensors are the secondary sensors. These embodiments are generally referred to herein as a “reverse offset” system.

While secondary sensors are generally more robust than primary sensors from a physical durability standpoint, primary sensors can provide greater accuracy due to their greater proximity (or target being closer) to molten polymeric material entering the mold cavity or feed system. It is found that systems can be developed that utilize readings from primary and secondary sensors to test the quality of signals from primary sensors in real time, identify and selectively monitor, filter, ignore, or attenuate errant primary sensor signals. Imminent or approaching failure of primary sensors can also be detected. The difference between a secondary sensor signal and a fully functioning primary sensor signal is defined herein as the “high-definition offset vector” or the “offset vector.”

Upon detection of errant primary sensor signals, manufacturing operations can failover to apply historical offsets to the secondary sensor signals on either a temporary or continuing basis. For instance, upon detection of an errant MPT signal, rather than employing data from the errant MPT signal in a control algorithm for adjusting screw velocity to maintain or modify melt pressure, pressure data from an immediately-previous shot at a time corresponding to the time at which the errant MPT signal was detected could be substituted for the errant MPT signal. Alternately, pressure data from another historically-recorded shot could be substituted for the errant MPT signal.

One manner of detecting errant MPT signals involves analyzing signal output behavior from the MPT, such as by analyzing whether the signal behavior is as expected, for example by scanning for abnormal jumps, sawtooth behavior, or other signatures indicative of a spurious signal. With this first level of quality check, no secondary signal would be relied upon for comparison. According to another manner of detecting errant MPT signals, comparisons of readings from primary and secondary sensors, identifying a range of acceptable variances or tolerances in discrepancies, and, in real-time or near-real-time, determining whether the variances are within or outside of such predetermined limits. Even if such comparisons reveal variances that are within an acceptable range, a system can be programmed to identify one or more changes in variances over a plurality of shots, or over a particular duration of time, indicative of a signal drift or other early indication of a potentially failing MPT sensor.

With sufficient collection of historical data, a manufacturing system can continue to operate for an extended period of time even with a faulty primary sensor, by substituting the historical data for the erroneous readings from the faulty primary sensor. By monitoring ambient conditions, fluctuations in media used in the manufacturing operation, and other variables that might impact the extent to which historical pressure data is likely to differ from actual data that could be collected from a fully functioning MPT sensor, a system of the present disclosure can be programmed to correct for expected deviation from historical pressure data. When operating a manufacturing system in such a manner, the MPT sensor is essentially a phantom or virtual primary sensor, thereby permitting uninterrupted operation even in the absence of a fully operational primary sensor.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

### BRIEF DESCRIPTION OF THE DRAWINGS

FIG. 1 is a schematic view of an injection molding system provided with primary and secondary sensors;

FIG. 2 is an example graph depicting the offset between melt pressure data produced by a MPT sensor and melt pressure data produced by a machine sensor;

FIG. 3 is a flow chart illustrating examples of the manner in which a system of the present disclosure may operate to detect errors in a primary sensor and steps the system may take to compensate for such errors;

FIGS. 4A-4C are example graphs depicting failure signatures of the error detection analyses disclosed herein; and

FIG. 5 is an example method for manufacturing molded parts using a high-definition pressure signal.

### DETAILED DESCRIPTION OF THE PREFERRED EMBODIMENTS

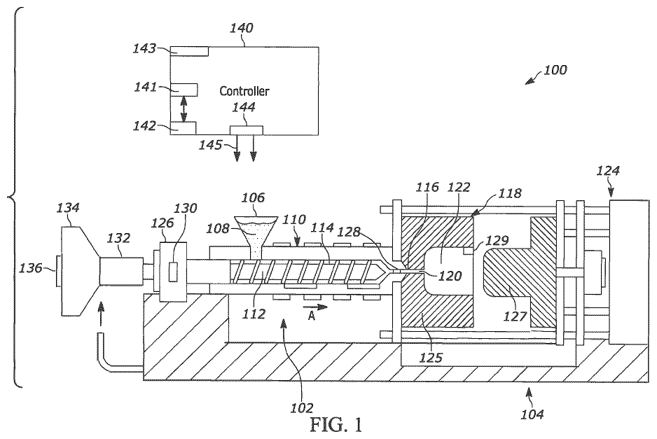

As illustrated in FIG. 1, a system for manufacturing products, such as an injection molding system 100 including an injection unit 102 and a clamping system 104, includes a hopper 106 adapted to accept material in the form of pellets 108 or any other suitable form. The hopper 106 feeds the pellets 108 into a heated barrel 110 of the injection unit 102. Upon being fed into the heated barrel 110, the pellets 108 may be driven to the end of the heated barrel 110 by a reciprocating screw 112. The heating of the heated barrel 110 and the compression of the pellets 108 by the reciprocating screw 112 causes the pellets to melt, thereby forming a molten plastic material 114.

The reciprocating screw 112 advances forward from a first position to a second position, in the A direction, and forces the molten plastic material 114 toward a nozzle 116 to form a shot of plastic material that will ultimately be injected into a mold cavity 122 of a mold 118 via one or more gates 120 which direct the flow of the molten plastic material 114 to the mold cavity 122. In other words, the reciprocating screw 112 is driven to exert a force on the molten plastic material 114.

The force exerted on the molten plastic material 114 may be a melt pressure. The melt pressure may be determined from a pressure or force exerted on machine sensor 130. If the injection molding machine 100 is controlled hydraulically, the pressure exerted on the machine sensor 130 may be a hydraulic pressure. The machine sensor 130 may be any type of sensor adapted to measure (either directly or indirectly) a property associated with the injection of the molten plastic material 114 by the screw 112. The machine sensor 130 may or may not be in direct contact with the molten plastic material 114. As an example, the sensor 130 may measure the properties of stress, strain, compressibility, rheology, load cell pressure, and/or hydraulic pressure.

If the injection molding machine 100 is controlled electrically, the force exerted on the machine sensor 130 may be a force exerted on a load cell on the back of the screw 112. The hydraulic pressure or force exerted on the machine sensor 130 may be exerted by motor 134 and ball screw 132. Additionally, sensor 136 may detect additional information associated with motor 134 such as the health of motor 134. Motor 134 may be a hydraulic motor or an electrical motor. Unless specifically described otherwise, any reference to the machine sensor 130 envisions the alternate use of the sensor 136 and/or other machine sensors.

In addition to the machine sensor 130, the melt pressure may be determined from sensor 128. The sensor 128 may be any type of sensor adapted to measure (either directly or indirectly) one or more characteristics of the molten plastic material 114 and/or portions of the machine 100. The sensor 128 may measure any characteristics of the molten plastic material 114 that are known and used in the art, such as, for example, a back pressure, temperature, viscosity, flow rate, hardness, strain, optical characteristics such as translucency, color, light refraction, and/or light reflection, or any one or more of any number of additional characteristics which are indicative of these. The sensor 128 may or may not be in direct contact with the molten plastic material 114. In some examples, the sensor 128 may be adapted to measure any number of characteristics of the injection molding machine 100 and not just those characteristics pertaining to the molten plastic material 114. As an example, the sensor 128 may be a pressure transducer that measures a melt pressure (during the injection cycle) and/or a back pressure (during the extrusion profile and/or recovery profile) of the molten plastic material 114 at the nozzle 116.

As previously noted, the sensor 128 may measure a back pressure exerted on the screw 112, but unlike in conventional systems where back pressure is measured on a trailing end of the screw 112, in the present approaches, back pressure is measured on a leading end of the screw 112. This positioning allows the sensor 128 to accurately measure the compressive pressure on the molten plastic material 114 as compared to measurements obtained at the trailing end of the screw 112 due to the compressible nature of the molten plastic material 114, draw in the barrel, and other factors. Although there are many options for the purchasing the type of sensor 128 that is used, there are no known machines that incorporate this sensor location for injection or back pressure control.

Similarly, the sensor 129 may be any type of sensor adapted to measure (either directly or indirectly) one or more characteristics of the molten plastic material 114 to detect its presence and/or condition in the mold cavity 122. In various embodiments, the sensor 129 may be located at or near an end-of-fill position in the mold cavity 122. The sensor 129 may measure any number of characteristics of the molten plastic material 114 and/or the mold cavity 122 that are known in the art, such as pressure, temperature, viscosity, flow rate, hardness, strain, optical characteristics such as translucency, color, light refraction, and/or light reflection, and the like, or any one or more of any number of additional characteristics indicative of these. The sensor 129 may or may not be in direct contact with the molten plastic material 114. As an example, the sensor 129 may be a pressure transducer that measures a cavity pressure of the molten plastic material 114 within the cavity 122.

As it is generally used herein, the term “proxy sensor” refers to arrangements of the sensor 128 and/or the sensor 129 that are not in direct contact with the molten plastic material 114.

Additionally, the melt pressure may be determined from properties of the molten plastic material 114. For example, the melt pressure may be determined from the drag and compressibility associated with molten plastic material 114. Still further, the melt pressure may be determined from properties of the screw 112. For example, the geometry of the screw, which may affect the friction and drag due to compression of the molten plastic material 114 may affect the melt pressure.

Calculating the melt pressure of the molten plastic material 114 may include calculating an error associated with the melt pressure. The error may be constant or variable. The error may vary linearly or non-linearly. Further the variation in the error may be dependent on the point-in-time of the fill cycle. For example, the error may be greater at the beginning of a fill cycle than at the end of the fill cycle of the injection molding machine 100. Further, the error may be due to the compressibility of the molten plastic material 114 or the drag of the molten plastic material 114 or both.

In other embodiments, the nozzle 116 may be separated from one or more gates 120 by a feed system (not illustrated). The mold cavity 122 is formed between the first and second mold sides 125, 127 of the mold 118 and the first and second mold sides 125, 127 are held together under pressure via a press or clamping unit 124.

The press or clamping unit 124 applies a predetermined clamping force during the molding process which is greater than the force exerted by the injection pressure acting to separate the two mold halves 125, 127, thereby holding together the first and second mold sides 125, 127 while the molten plastic material 114 is injected into the mold cavity 122. To support these clamping forces, the clamping system 104 may include a mold frame and a mold base, in addition to any other number of components, such as a tie bar.

Once the shot of molten plastic material 114 is injected into the mold cavity 122, the reciprocating screw 112 halts forward movement. The molten plastic material 114 takes the form of the mold cavity 122 and cools inside the mold 118 until the plastic material 114 solidifies. Upon solidifying, the press 124 releases the first and second mold sides 125, 127, which are then separated from one another. The finished part may then be ejected from the mold 118. The mold 118 may include any number of mold cavities 122 to increase overall production rates. The shapes and/or designs of the cavities may be identical, similar to, and/or different from each other. For instance, a family mold may include cavities of related component parts intended to mate or otherwise operate with one another. In some forms, an “injection cycle” is defined as of the steps and functions performed between commencement of injection and ejection. Upon completion of the injection cycle, a recovery profile is commenced during which the reciprocating screw 112 returns to the first position, opposite direction A.

The injection molding machine 100 also includes a controller 140 communicatively coupled with the machine 100 via connection 145. The connection 145 may be any type of wired and/or wireless communications protocol adapted to transmit and/or receive electronic signals. In these examples, the controller 140 is in signal communication with at least one sensor, such as, for example, the machine sensor 130, the sensor 128, the sensor 129, and/or the sensor 136.

The controller 140 can be disposed in a number of positions with respect to the injection molding machine 100. As examples, the controller 140 can be integral with the machine 100, contained in an enclosure that is mounted on the machine, contained in a separate enclosure that is positioned adjacent or proximate to the machine, or can be positioned remote from the machine. In some embodiments, the controller 140 can partially or fully control functions of the machine via wired and/or wired signal communications as known and/or commonly used in the art.

The controller 140 includes software 141 adapted to control its operation, any number of hardware elements 142 (such as, for example, a non-transitory memory module and/or processors), any number of inputs 143, any number of outputs 144, and any number of connections 145. The software 141 may be loaded directly onto a non-transitory memory module of the controller 140 in the form of a non-transitory computer readable medium, or may alternatively be located remotely from the controller 140 and be in communication with the controller 140 via any number of controlling approaches. The software 141 includes logic, commands, and/or executable program instructions which may contain logic and/or commands for controlling the injection molding machine 100 according to an injection cycle. The software 141 may or may not include an operating system, an operating environment, an application environment, and/or a user interface.

The hardware 142 uses the inputs 143 to receive signals, data, and information from the injection molding machine 100 being controlled by the controller 140. For example, each of the sensors 128, 129, 130, and 136 may be in signal communication (either directly or indirectly) with the controller 140 via the inputs 143.

Additionally, the hardware 142 uses the outputs 144 to send signals, data, and/or other information to the injection molding machine. For example, the controller 140 may be in signal communication with a screw control 126. The screw control 126 may be an actuator that controls advancement of the reciprocating screw 112. In some embodiments, the controller 140 generates a signal which is transmitted from an output 144 of the controller 140 to the screw control 126. The controller 140 can control any number of characteristics of the machine, such as injection pressures (by controlling the screw control 126 to advance the screw 112 at a rate which maintains a desired value corresponding to the molten plastic material 114 in the nozzle 116), barrel temperatures, clamp closing and/or opening speeds, cooling time, inject forward time, overall cycle time, pressure set points, ejection time, screw recovery speed, back pressure values exerted on the screw 112, and screw velocity.

The connection 145 represents a pathway through which signals, data, and information can be transmitted between the controller 140 and its injection molding machine 100. In various embodiments this pathway may be a physical connection or a non-physical communication link that works analogous to a physical connection, direct or indirect, configured in any way described herein or known in the art. In various embodiments, the controller 140 can be configured in any additional or alternate way known in the art.

In some embodiments, the controller 140 is native to the injection molding machine 100. In other embodiments, the controller 140 is a remote controller communicatively coupled to a native controller of the injection molding machine 100. For example, in the remote controller embodiments, the controller 140 may be retrofit onto the injection molding machine 100 by disconnecting sensors from the native controller and reconnecting the sensors to the controller 140 and/or installing new sensors onto the injection molding machine 100 that are coupled to the controller 140. As another example, the retrofit controller 140 may directly control operation of the injection molding machine 100 via the outputs 144. In other embodiments, the retrofit controller 140 may include a conversion module to output control signals to the native controller to cause the native controller to generate control signals that manifest in the manner determined by the retrofit controller 140.

To execute an injection cycle in accordance with the software 141, the controller 140 may implement an injection pattern that includes one or more setpoint values for the control parameters that form an injection pattern. In some embodiments, the injection pattern defines a substantially constant pressure profile. Of course, the injection pattern may define other pressure profiles (e.g., a conventional, high pressure injection molding process). Additionally, while the controller 140 is described herein as implementing an “injection cycle,” it is envisioned that the disclosed techniques for generating a high-fidelity pressure signal can be utilized by an alternate controller that implements an extrusion process. Accordingly, the term “actuation cycle” encompasses both injection processes and extrusion processes.

In operation, the controller 140 may implement closed loop control techniques that to ensure that the injection molding machine 100 exhibits the response set out in the injection pattern. For example, the controller 140 may include a proportional-integral-derivative (PIO) controller configured to control a particular control parameter of the injection molding process (e.g., melt pressure or screw velocity) controlled by the controller 140 via the outputs 144. The PIO controller compares data obtained via the inputs 143 to one or more setpoint values included in the injection pattern. Based on this error, the controller 140 may generate an output 144 that adjusts operation of the injection molding machine 100 in a manner that mitigates the error.

As described above, because melt pressure transducers (MPT) sensors generally provide more accurate measurement of melt pressure than a machine sensor, calculating the closed-loop error based on the output of an MPT sensor produces an output 144 that is more likely to control the injection molding machine 100 in manner that produces an acceptable molded part (e.g., a molded part within the design tolerances). Accordingly, the sensor 128 may serve as a primary sensor and be in the form of a MPT sensor. Additional primary MPT sensors (e.g., the sensor 129) may be provided within the mold cavity, such as to monitor flow front position during a shot of the molten material 114 into the mold cavity 122. Alternatively, the primary sensor may instead take the form of an ultrasonic sensor or a proxy sensor, such as a strain gauge sensor, to indirectly measure melt pressure within the mold cavity 122. Unless specifically described otherwise, any reference to the MPT sensor 128 envisions the alternate use of the sensor 129 or a proxy sensor.

However, as described above, data generated by MPT sensors are more accurate, but prone to error, such as error introduced by electromagnetic interference (EMI), physical component degradation, signal drift, etc., caused by being located near the flow front of the molten material 114. In the event these types of errors occur, the signal produced by the MPT sensor does not represent the true melt pressure acting upon the molten material 114. Because the output of the MPT sensor is used as the basis for controlling the injection molding machine 100, the error in the pressure signal generated by the MPT sensor is propagated to the PIO controller which generates an error signal that also does not reflect the true closed-loop control error. Thus, the controller 140 will produce outputs 144 that degrade the quality of the molded part.

On the other hand, the machine sensors 130, 136 are more remote from the extreme conditions to which the primary MPT sensor 128 is exposed. Machine plastic pressure sensors such as load cell 136 are widely regarded as robust, error-resistant, long-lasting sensors. However, given their lack of immediate proximity to molten material 114 within the mold cavity 122, data from such machine plastic pressure sensors 130 is not necessarily as granular or reliable as data from the primary MPT 128. Regardless, in the event of a failure associated with the primary MPT sensor 128, the data signal output by the machine sensors 130, 136 may still be utilized for closed-loop control of the injection molding machine 100. As such, in some embodiments, the software 141 may be configured to detect an error in the signal produced by the primary MPT sensor 128 and, in response to detecting the error, change the input signal to the PIO controller to instead be based on the machine sensors 130, and not the primary MPT sensor 128 in real or near-real time.

It should be appreciated that while both the machine sensor 130 and the MPT sensor 128 may be configured to provide sensor data indicating a melt pressure, due to their different locations and/or the differences in how their pressure data is generated, the melt pressure output by the machine sensor 130 and the melt pressure output by the MPT sensor 128 are offset from one another. If the setpoint pattern associated with the injection cycle is tuned to control the injection molding machine 100 based on sensor data reported by the MPT sensor 128, the setpoint pattern does not indicate the appropriate values for controlling the injection molding machine 100 based on the melt pressure data output by the machine sensor 130, and vice versa. Accordingly, to maintain the intended operation of the injection molding machine 100, the controller 140 is configured to quantify the offset (i.e., a “delta”) between the melt pressure data output by the machine sensor 130 and the melt pressure data output by the MPT sensor 128. Thus, when switching between melt pressure data sources, the controller 140 may apply the offset to the new melt pressure data source prior to inputting the melt pressure to the PIO controller. Said another way, by applying the offset to the melt pressure output of the machine sensor 130, the input to the PIO controller approximates the melt pressure value the would be output by the MPT sensor 128 when properly functioning.

It should be appreciated that by quantifying the offset between the machine sensor 130 and the MPT sensor 128, the controller 140 is able to switch between melt pressure data sources with minimal delay (e.g., less than 10 milliseconds (ms), less than 5 ms, less than 3 ms, etc.). As such, the controller 140 may be able to switch data sources within an injection cycle and still produce an acceptable molded part. Additionally, being able to readily switch data sources enables operators of the injection molding machine 100 to continue the run of injection cycles without stopping to repair the MPT sensor 128 and/or reconfigure the controller 140 with a new set of setpoint values. This enables the operator to reduce injection molding machine downtime by scheduling repair of the MPT sensor 128 during a pre-planned stoppage period.

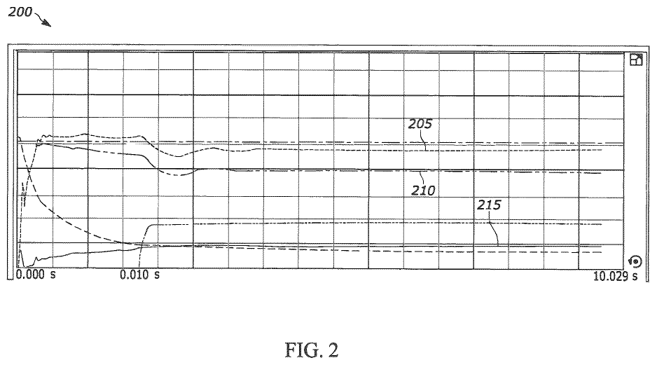

With simultaneous reference to FIG. 2, illustrated is an example graph 200 depicting the offset (as represented by line 215) between melt pressure data produced by the MPT sensor 128 (as represented by the line 205) and melt pressure data produced by the machine sensor 130 (as represented by the line 210). As illustrated, the signal 215 that represents the offset vector increases approximately linearly from the ramp period of the injection cycle until the gate seal during the hold phase of the injection cycle, and remains relatively constant thereafter. Thus, the offset between the MPT signal 205 and the machine pressure signal 210 varies throughout the injection cycle.

Accordingly, to quantify the offset between the MPT signal 205 and the machine pressure signal 210, the controller 140 may be configured to store an offset vector 215 that stores offset values for different portions of the injection cycle. For example, the offset vector 215 may include samples for every 1-5 ms of the injection cycle. Thus, in the event of a failure of the primary, the offset applied to the machine pressure signal 210 prior to inputting the pressure data to the PIO controller accounts for the shifts in the offset throughout the injection cycle. As a result, the secondary pressure signal produced by adding the offset to the machine pressure signal 210 more closely matches the expected the primary pressure data throughout the injection cycle.

It should be appreciated that due to changes in operating conditions (e.g., viscosity of the molten material, humidity, wear and tear, etc.) the offset between the melt pressures produced by the MPT sensor 128 and the machine sensor 130 changes over time. Accordingly, the techniques disclosed herein relate to adjusting the offset vector 215 over time to maintain an accurate representation of the melt pressure data offset in case there is a need to switch to control via the secondary sensor, the injection molding machine still exhibits a response that closely matches the response when controlled using the primary sensor.

In one example, the controller 140 maintains the offset vector 215 as a rolling average of the offset a predetermined number of prior injection cycles (e.g., five cycles, ten cycles, 25 cycles, etc.). As another example, the controller 140 detects a threshold difference in the offset during a most recent injection cycle and the stored offset vector (e.g., a difference of 2%, 5%, 10%, etc. in an error metric between the offset vectors). In yet another example, the controller 140 is configured to periodically update the offset vector 215 (e.g., every 8 hours, every 100 cycles, etc.).

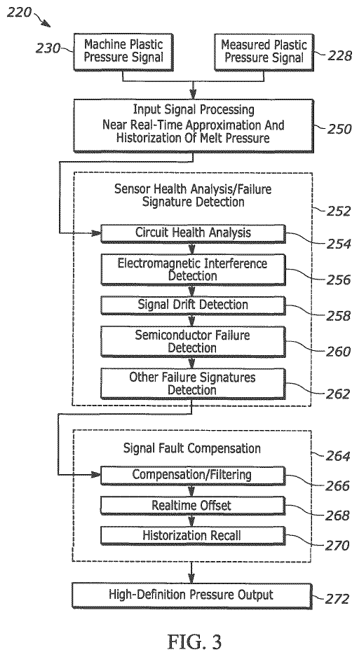

FIG. 3 schematically illustrates a flowchart 220 for utilizing a machine plastic pressure signal 230 (e.g., a pressure signal produced by the machine sensor 130) and a measured plastic pressure signal 228 (e.g., a pressure signal produced by the MPT sensor 128) to attain a high-definition pressure output 272. In some embodiments, the actions described with respect to the flowchart 220 are performed by the controller 140 of the injection molding machine 100. It should be appreciated that while the description of FIG. 3 assumes that the measured plastic pressure signal 228 is the primary pressure signal, in other embodiments (referred to herein as “reverse offset embodiments”), the machine plastic pressure signal 230 is the primary pressure signal. Accordingly, any techniques described below with respect to the use of the measured plastic pressure signal 228 as the primary pressure signal envision the alternate implementation in a reverse offset embodiment that use the machine plastic pressure signal 230 as the primary pressure signal.

At the input signal processing step 250, the controller 140 processes the machine plastic pressure signal 230 and/or the measured plastic pressure signal 228. For example, the controller 140 may convert the voltage levels of the signals 228, 230 to corresponding melt pressure values based on a known conversion associated with the MPT sensor 128 and the machine sensor 130, respectively. Additionally, the controller 140 may calculate an offset between the signals 228, 230 to produce an offset vector for historization. As described above, the offset vector may include multiple samples of the offset between the signals 228, 230 throughout the execution of an injection cycle.

Additionally, in some embodiments, the controller 140 may historize the measured plastic pressure signal 228 for use in a subsequent injection cycle should a failure be detected during a future execution of the sensor health analysis/failure signature detection stage 252. Similar to historizing the offset vector, the controller 140 may store a plurality of samples of the measured plastic pressure signal 228 such that the controller 140 is able to provide historized pressure data that reflects the changes in the measured plastic pressure signal 228 throughout the execution of an injection cycle. In some embodiments, the historized measured plastic pressure signal 228 is a rolling average of prior measured plastic pressure signal 228 (e.g., the average measured plastic pressure signal 228 data from the prior three, five, ten, etc. injection cycles).

At the sensor health analysis/failure signature detection stage 252, the controller 140 analyzes the signals 228, 230 to determine whether the primary sensor (typically the MPT sensor 128) is functioning properly. While the flowchart 220 depicts a sequential order for the signature detection analyses 254-262, in alternate embodiments, a different sequence of signature detection analyses 254-262 may be implemented. In some further alternate embodiments, two or more of the signature detection analyses 254-262 may be performed in parallel. It should be appreciated that the signature detection analysis 254-262 may be performed within 1-5 ms.

In some embodiments, if the controller 140 has previously detected a failure signature during a previous execution of the sensor health analysis/failure signature detection stage 252, the controller 140 may skip the analyses 254-262 and proceed to a signal fault compensations step 264. In other embodiments, the controller 140 may continue to perform the analyses 254-262 to detect whether the failure signature has stopped manifesting (and/or has stopped manifesting for a threshold duration (e.g., 100 cycles, 200 cycles, etc.).

Starting with the circuit health analysis 254, the controller 140 may perform a circuit continuity check by comparing the measured plastic pressure signal 228 to an out-of-range threshold. To this end, the measured plastic pressure signal 228 exceeding the out-of-range threshold may indicate an error in the ability of the MPT 128 physically sense a melt pressure (such as when physical components of the MPT sensor 128 are damaged by the molten material). In this scenario, the MPT sensor 128 may output a voltage signal indicative of the error (e.g., 16V).

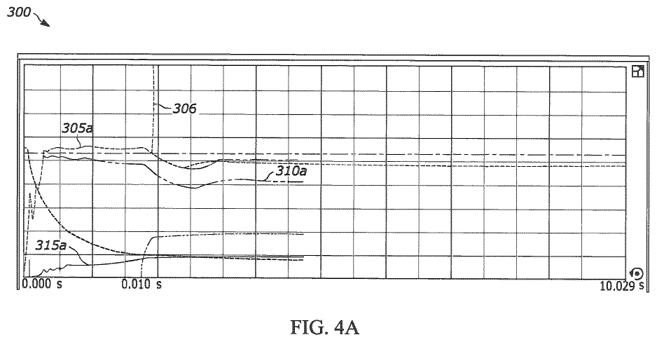

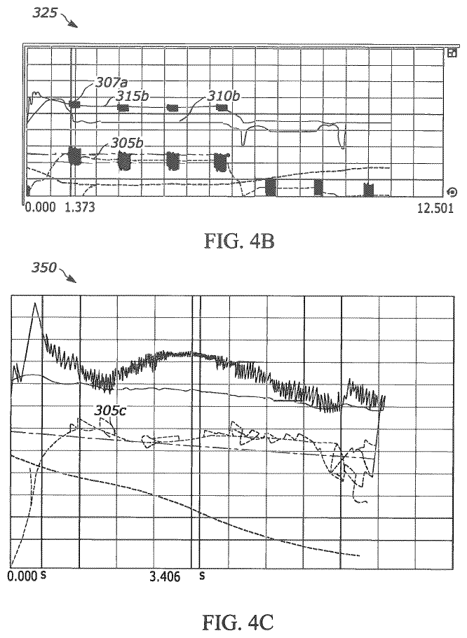

With simultaneous reference to FIG. 4A, illustrated is an example graph 300 showing an example signature that fails the circuit health analysis 254. More particularly, the graph 300 depicts melt pressure data derived from the measured plastic pressure signal 228 (as represented by the line 305a) and melt pressure data derived from the machine plastic pressure signal 230 (as represented by the line 310a) and the offset therebetween (as represented by the line 315a). As shown in the graph 300, shortly after time .010 seconds the line 305a includes a vertical asymptote 306 indicating that measured plastic pressure signal 228 produced a voltage value that is out-of-range. Accordingly, the controller 140 may detect a failure in circuit health by either detecting a voltage value of the measured plastic pressure signal 228 or by detecting the out-of-range threshold represented by the vertical asymptote 306 in the pressure signal derived therefrom.

Turning to the electromagnetic interference (EMI) detection analysis 256, the controller 140 may detect the presence of EMI present in the measured plastic pressure signal 228. The data signature of the EMI may manifest itself as a local signal anomaly in the offset vector. Accordingly, if the controller 140 detects the presence of the local signal anomaly for at least a predetermined duration (e.g., 1 ms, 10 ms, 100 ms, etc.), the controller 140 may determine that EMI is impacting the measured plastic pressure signal 228. As one example, the controller 140 may detect the presence of the anomaly by determining that the derivative of the offset signal, or the absolute value thereof, exceeds a threshold value. In some embodiments, the controller 140 additionally detects that the anomaly occurs for a threshold duration (e.g., 2 ms, 10 ms, 15 ms, and so on).

With simultaneous reference to FIG. 4B, illustrated is an example graph 325 showing an example signature that fails the EMI detection analysis 256. More particularly, the graph 325 depicts melt pressure data derived from the measured plastic pressure signal 228 (as represented by the line 305b) and melt pressure data derived from the machine plastic pressure signal 230 (as represented by the line 310b) and the offset therebetween (as represented by the line 315b). As shown in the graph 325, the offset signal at time 1.373 seconds is in the middle of a local signal anomaly event 307 characterized by a period in which the offset signal rapidly changes value. This local anomaly signatures occurs three additional times later in the injection cycle. Accordingly, the controller 140 may detect an EMI failure signature by either detecting that the duration of the local signal anomaly 307 exceeds a threshold and/or that a total number of local signal anomalies that occurred during an injection cycle exceeds a threshold.

Turning to the signal drift analysis 258, the controller 140 may detect that the offset signal has shifted from a reference level by a threshold amount. As described above, in some embodiments the controller 140 is configured to detect a relatively small amount of signal drift to update the stored offset vector.

Accordingly, in these embodiments, the threshold amount of drift detected during the signal drift analysis 258 is larger than the threshold required to update the stored offset vector and/or is determined based upon a different reference offset vector (e.g., a difference of 10%, 15%, 25%, etc. in an error metric between the offset vectors). In some embodiments, the error metric is a difference between the average offset of the offset samples included in the offset vectors.

Turning to the semiconductor failure analysis 260, the controller 140 may detect a failure in the physical components included in the MPT sensor 128. A common type of semiconductor failure that occurs is due to delamination, which manifests by introducing sawtooth shaped artifacts in the measured plastic pressure signal 228. Accordingly, the controller 140 may be configured to analyze the measured plastic pressure signal 228 to detect a threshold number of sawtooth artifacts.

With simultaneous reference to FIG. 4C, illustrated is an example graph 350 showing an example signature that fails the semiconductor failure analysis 260. More particularly, the graph 350 depicts melt pressure data derived from the measured plastic pressure signal 228 (as represented by the line 305c). As shown in FIG. 4C, the line 305c includes many sawtooth artifacts, degrading the quality of the measured plastic pressure signal 228.

It should be appreciated that the particular primary sensor failure conditions described with respect to tests 254-260 are merely example failure conditions and different embodiments may include additional, fewer, and/or alternate failure conditions. Accordingly, the sensor health analysis/failure signature detection stage 252 also includes a catch-all other failure signature detection analysis block 262 at which the controller 140 is configured to detect the alternate and/or additional failure conditions.

If the controller 140 did not detect a failure signature during the sensor health analysis/failure signature detection stage 25, or, in some embodiments, if the failure signature is no longer detected, the controller 140 may skip the signal fault compensation step 264 and report the measured plastic pressure signal 228 as the high-definition pressure output 272. On the other hand, if the controller 140 does detect a failure condition in any of the analyses 254-262, the controller 140 may compensate for the failure via the signal fault compensation step 264.

During the signal fault compensation step 264, the controller 140 applies techniques to produce a high-definition pressure output that compensates for the measured plastic pressure signal 228 being an unreliable input for closed loop control of the injection molding machine 100. While the flowchart 220 depicts a sequential order for the compensation techniques 266-270, the ordering represents a general preference of the compensation techniques 266-270. Accordingly, the controller 140 may only perform a single one of the compensation techniques 266-270 in any given injection cycle.

Starting with the compensation/filtering techniques 266, in some scenarios the failure signature may be resolved by applying signal processing techniques that improve the measured plastic pressure signal 228. For example, smoothing techniques may improve the quality of the measured plastic pressure signal 228 in the event of semiconductor delamination. As other examples, the controller 140 may perform outlier identification and exclusion, time-based filtering and time-weighted filtering techniques, as well as other techniques known in the art.

Next, the controller 140 may perform realtime offset compensation 268. During this step, the controller 140 may add the offset vector to the machine plastic pressure signal 230 to produce the high-definition pressure output 272. More particularly, when executing an injection cycle, the controller 140 may identify a current time within the injection cycle and add the corresponding sample included in the offset vector to the machine plastic pressure signal 230. As a result, the controller 140 inputs into the closed loop control process a pressure signal that appears to have been generated by the MPT 128, but is actually derived from the machine sensor 130. It should be appreciated that in the reverse offset embodiments, the controller 140 may instead subtract the offset vector samples from the measured plastic pressure signal 228 to produce the high-definition pressure output 272.

Additionally, the controller 140 may perform historization recall techniques 270 to substitute historical measured plastic pressure data for the measured plastic pressure signal 228. It should be appreciated that the viscosity of the molten plastic material 114 changes over time. Accordingly, when relying on historized measure plastic pressure data, the controller 140 may identify a number of cycles that have occurred since the historized measured plastic pressure data was collected and apply a correction factor that accounts for the shift in viscosity. As such, when the controller 140 implements the historization recall techniques 270, the controller 140 is still able to account for dynamic changes in the operating conditions.

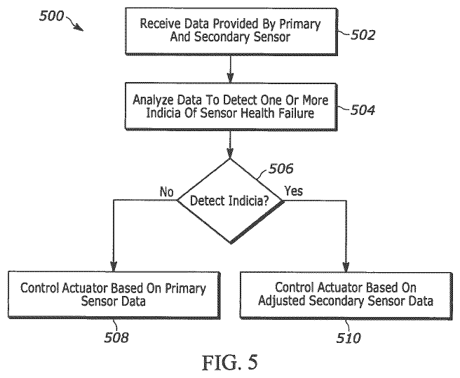

FIG. 5 illustrates an exemplary method 500 for manufacturing products. The method 500 may be performed by operating a controller (such as the controller 140) of a molding machine (such as the injection molding machine 100 or an extrusion molding machine) in accordance with a program stored on a non-transitory memory. The molding machine may include an actuator (such as the screw control 126) configured to control advancement of a molten material advancement device (such as the reciprocating screw 112).

The molding machine may also include at least one primary pressure sensor. For example, the primary pressure sensor may be a melt pressure transducer (MPT) sensor in direct contact with molten material (such as the molten plastic material 114) downstream of the molten material advancement device (such as the MPT sensor 128 or sensor 129), or (ii) a proxy sensor that, while not being in direct contact with molten material, provides data indicative of pressure of molten material downstream of the molten material advancement device. The molding machine may also include at least one secondary pressure sensor (such as the machine sensor 130 and/or 136) not in direct contact with molten material downstream of the molten material advancement device.

The method 500 may begin at block 502 when the controller receives data provided by both the at least one primary sensor and the at least one secondary sensor. In some embodiments, the controller may calculate a plurality of deltas between the data provided by the at least one secondary sensor and the data provided by the at least one primary sensor at a plurality of times throughout an actuation cycle of the molten material advancement device. The plurality of deltas may form an offset vector representative of an offset signal (such the offset signals 215, 315).

In some embodiments, the controller stores a historical offset vector in a memory of the controller, wherein the historical offset vector is based on a plurality of deltas calculated at a plurality of times throughout a previous actuation cycle of the molten material advancement. In these embodiments, the controller may be configured to detect that an average of the plurality of deltas calculated during the actuation cycle of the molten material advancement device exceeds an average of the plurality of deltas indicated in the historical offset vector by a threshold value and update the stored offset vector to be based on the plurality of deltas calculated during the actuation cycle of the molten material advancement device in response thereto. Additionally or alternatively, in some embodiments, the controller may be configured to detect a temporal trigger to update the stored offset vector and updating, via the controller, the stored offset vector to be based on the plurality of deltas calculated during the actuation cycle of the molten material advancement device in response thereto.

At block 504, the controller analyzes the data provided by the at least one primary sensor to detect whether one or more indicia of sensor health failure are present. In some embodiments, the indicia of sensor health failure indicate that the pressure data received from the at least one primary sensor is outside of an expected range of pressure values. For example, the controller may perform the analyses 254-262. Accordingly, in some embodiments, the controller detects that the plurality of deltas between the data provided by the at least one secondary sensor and the data provided by the at least one primary sensor for the actuation cycle of the molten material advancement device exhibits a pattern indicative of the sensor health failure.

When an indicia of sensor health failure is not present (the “NO” branch of decision 506), the controller proceeds to block 508 where the controller controls the actuator in a manner that adjusts a velocity of the molten material advancement device to achieve a desired melt pressure at the primary sensor based on pressure data received from the at least one primary sensor.

On the other hand, when an indicia of sensor health failure is present (the “YES” branch of decision 506), the controller proceeds to block 510 where the controller controls the actuator of the molten material advancement device in a manner that adjusts the velocity of the molten material advancement device based on adjusted pressure data received from the at least one secondary sensor to achieve the desired melt pressure. For example, the controller may implement the realtime offset techniques 268. As a result, in some embodiments, the controller is able to switch control techniques during the actuation cycle of the molten material advancement device in which the controller detects the sensor health failure.

In some alternate embodiments, the controller instead controls the actuator of the molten material advancement device in a manner that adjusts the velocity of the molten material advancement device based on historical pressure data received from the at least one primary sensor to achieve the desired melt pressure at block 510. For example, the controller may implement the historization recall techniques 270. In these embodiments, the controller may be configured to determine a number of cycles that have occurred and since the reception of the historical pressure data and based on the number of cycles, scale the historical pressure data to account for a shift in viscosity of the molten material.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for manufacturing products, comprising:
providing an actuator configured to control advancement of a molten material advancement device;
providing at least one primary pressure sensor, the primary pressure sensor being one of (i) a melt pressure transducer sensor in direct contact with molten material downstream of the molten material advancement device, or (ii) a proxy sensor that, while not being in direct contact with molten material, provides data indicative of pressure of molten material downstream of the molten material advancement device;
providing at least one secondary pressure sensor not in direct contact with molten material downstream of the molten material advancement device;
providing a controller in communication with each of the at least one secondary pressure sensor, the actuator, and the at least one primary sensor;
operating the controller according to a program stored on a non-transitory computer readable medium to:
receive the data provided by both the at least one primary sensor and the at least one secondary sensor,
analyze the data provided by the at least one primary sensor to detect one or more indicia of sensor health failure, and
when an indicia of sensor health failure is not detected,
control the actuator in a manner that adjusts a velocity of the molten material advancement device to achieve a desired melt pressure at the primary sensor based on pressure data received from the at least one primary sensor, and
when an indicia of sensor health failure is detected,
control the actuator of the molten material advancement device in a manner that adjusts the velocity of the molten material advancement device based on adjusted pressure data received from the at least one secondary sensor to achieve the desired melt pressure.

2. The method of claim 1, wherein operating the controller to detect the one or more indicia of sensor health failure comprises:
detecting, via the controller, that the pressure data received from the at least one primary sensor is outside of an expected range of pressure values.

3. The method of claim 1, wherein during an actuation cycle of the molten material advancement device, operating the controller comprises:
calculating, via the controller, a plurality of deltas between the data provided by the at least one secondary sensor and the data provided by the at least one primary sensor at a plurality of times throughout the actuation cycle of the molten material advancement device.

4. The method of claim 3, wherein operating the controller to detect the one or more indicia of sensor health failure comprises:
detecting, via the controller, that the plurality of deltas between the data provided by the at least one secondary sensor and the data provided by the at least one primary sensor for the actuation cycle of the molten material advancement device exhibits a pattern indicative of the sensor health failure.

5. The method of claim 4, wherein operating the controller comprises:
storing, via the controller, a historical offset vector in a memory of the controller, wherein the historical offset vector is based on a plurality of deltas calculated at a plurality of times throughout a previous actuation cycle of the molten material advancement device.

6. The method of claim 5, wherein operating the controller comprises:
detecting, via the controller, that an average of the plurality of deltas calculated during the actuation cycle of the molten material advancement device exceeds an average of the plurality of deltas indicated in the historical offset vector by a threshold value; and
in response to detection, updating, via the controller, the stored offset vector to be based on the plurality of deltas calculated during the actuation cycle of the molten material advancement device.

7. The method of claim 6, wherein operating the controller comprises:
detecting, via the controller, a temporal trigger to update the stored offset vector; and
in response to the detection, updating, via the controller, the stored offset vector to be based on the plurality of deltas calculated during the actuation cycle of the molten material advancement device.

8. The method of claim 1, wherein operating the controller to control the actuator in a manner that adjusts the velocity of the molten material advancement device based on adjusted pressure data received from the at least one secondary sensor to achieve the desired melt pressure occurs during an actuation cycle of the molten material advancement device in which the controller detects the sensor health failure.

9. The method of claim 1, wherein operating the controller comprises:
analyzing, via the controller, the data provided by the at least one primary sensor to detect a resolution of the sensor health failure, and
in response to detecting the resolution of the sensor health failure, resuming, via the controller, control of the actuator in a manner that adjusts a velocity of the molten material advancement device to achieve the desired melt pressure at the primary sensor based on the pressure data received from the at least one primary sensor.

10. A method for manufacturing products, comprising:
providing an actuator configured to control advancement of a molten material advancement device;
providing at least one secondary pressure sensor, the secondary pressure sensor being one of (i) a melt pressure transducer sensor in direct contact with molten material downstream of the molten material advancement device, or (ii) a proxy sensor that, while not being in direct contact with molten material, provides data indicative of pressure of molten material downstream of the molten material advancement device;
providing at least one primary pressure sensor not in direct contact with molten material downstream of the molten material advancement device;
providing a controller in communication with each of the at least one secondary pressure sensor, the actuator, and the at least one primary sensor;
operating the controller according to a program stored on a non-transitory computer readable medium to:
receive the data provided by both the at least one primary sensor and the at least one secondary sensor,
analyze the data provided by the at least one primary sensor to detect one or more indicia of sensor health failure, and
when an indicia of sensor health failure is not detected,
control the actuator in a manner that adjusts a velocity of the molten material advancement device to achieve a desired melt pressure at the primary sensor based on pressure data received from the at least one primary sensor, and
when an indicia of sensor health failure is detected,
control the actuator of the molten material advancement device in a manner that adjusts the velocity of the molten material advancement device based on adjusted pressure data received from the at least one secondary sensor to achieve the desired melt pressure.

11. A method for manufacturing products, comprising:
providing an actuator configured to control advancement of a molten material advancement device;
providing at least one primary pressure sensor, the primary pressure sensor being one of (i) a melt pressure transducer sensor in direct contact with molten material downstream of the molten material advancement device, or (ii) a proxy sensor that, while not being in direct contact with molten material, provides data indicative of pressure of molten material downstream of the molten material advancement device;
providing at least one secondary pressure sensor not in direct contact with molten material downstream of the molten material advancement device;
providing a controller in communication with each of the at least one secondary pressure sensor, the actuator, and the at least one primary sensor;
operating the controller according to a program stored on a non-transitory computer readable medium to:
receive the data provided by both the at least one primary sensor and the at least one secondary sensor,
analyze the data provided by the at least one primary sensor to detect one or more indicia of sensor health failure, and
when an indicia of sensor health failure is not detected,
control the actuator in a manner that adjusts a velocity of the molten material advancement device to achieve a desired melt pressure at the primary sensor based on pressure data received from the at least one primary sensor, and
when an indicia of sensor health failure is detected,
control the actuator of the molten material advancement device in a manner that adjusts the velocity of the molten material advancement device based on historical pressure data received from the at least one primary sensor to achieve the desired melt pressure.

12. The method of claim 11, wherein controlling the actuator based on historical pressure data comprises:
determining, via the controller, a number of cycles that have occurred and since the reception of the historical pressure data; and
based on the number of cycles, scaling, via the controller, the historical pressure data to account for a shift in viscosity of the molten material.
